(19) United States
(12) Patent Application Publication
(10) Pub. No.: US 2010/0102270 A1
(43) Pub. Date: Apr. 29, 2010

(54) Method for Preparing Lithium Iron Phosphate as a Positive Electrode Active Material for a Lithium Ion Secondary Battery

(76) Inventors: Wenwen Jia, Shenzhen (CN); Chaqing Xu, Shenzhen (CN); Xiaoyong Chen, Shenzhen (CN)

Correspondence Address: BRINKS HOFER GILSON & LIONE, P.O. BOX 10395, CHICAGO, IL, 60610, US

(21) Appl. No.: 12/593,424

(22) PCT Filed: Apr. 1, 2008
(86) PCT No.: PCT/CN08/70656

§ 371 Date: Sep. 28, 2009

(30) Foreign Application Priority Data
May 28, 2007 (CN) 200710103095.X
Aug. 28, 2007 (CN) 200710147590.0
Nov. 26, 2007 (CN) 200710187560.2

(51) Int. Cl. H01M 4/88

(52) U.S. Cl. 252/182.1

(57) ABSTRACT

Disclosed herein is a method for preparing lithium iron phosphate as a positive electrode active material for a lithium ion secondary battery comprising drying and sintering a mixture containing a lithium source, ferric oxide, phosphoric acid, a carbon source, and a solvent, in which the solvent is water and/or water soluble organic solvent. The lithium iron phosphate prepared by the inventive method has small particle size and uniform particle size distribution, and the battery prepared from the lithium iron phosphate has high initial discharge specific capacity, and good large-current discharge property and cycle performance.

### FIELD OF THE INVENTION

The present invention relates to a method for preparing a battery positive electrode active material, more specifically, to a method for preparing lithium iron phosphate as a positive electrode active material for a lithium ion secondary battery.

### BACKGROUND OF THE INVENTION

The lithium ion battery, as a chemical power source with high specific capacity, has already been widely used in various fields such as mobile communication, notebook computer, camcorder, camera, and portable device, and it is also the most preferred power source equipped for electric cars and space power sources intensively researched worldwide, as well the most preferred renewable energy. The research of the positive electrode active material for the lithium ion battery is focused on LiFePO₄, because compared with other positive electrode active materials for the lithium ion battery, LiFePO₄ has good electrochemical properties, stable charge-discharge flat potential plateau, and stable structure during charge-discharge process, and LiFePO₄ also has the advantage of non-toxicity, no pollution, good safety, applicability at a high temperature, and abundant raw material resources.

In prior art, to homogeneously mix various raw materials for LiFePO₄ preparation, the conventionally adopted preparation method comprises mixing a soluble lithium source, an iron source, and a phosphorus source in a liquid medium with a carbon source dissolved therein, and drying and calcining the mixture. For example, CN 1442917A discloses a method for preparing LiFePO₄ comprising the steps of: dissolving polyol or saccharide in distilled water, and adding a lithium source, an iron source, and a phosphorus source thereto; and intensively stirring the mixture, drying in inert atmosphere, and calcining in Ar or N₂ atmosphere to give carbon-coated LiFePO₄ composite conductive nanomaterial. It also in detailed discloses that: (1) the whole preparation is carried out in Ar or N₂ atmosphere, (2) the calcination temperature is 600-1,000, (3) the reaction time is 0.5-24 hr, wherein the iron source is ferrous oxalate and/or ferrous hydroxide, the phosphorus source is one or more of H₃PO₄, NH₄H₂PO₄, (NH₄)₂HPO₄, and (NH₄)₃PO₄.

The obtained lithium iron phosphate (LiFePO₄) by the aforementioned method has large particle size, non-uniform particle size distribution, and high production cost. When it is used as positive electrode active material for a lithium ion secondary battery, the obtained battery has low initial discharge specific capacity, and poor high-current discharge performance and cycle performance.

In prior art, insoluble ferric phosphate also can be adopted as phosphorus source and iron source, for example, CN 1821062A discloses a method for preparing carbon-coated lithium iron phosphate, comprising: (1) weighing ferric phosphate, lithium acetate, and reductant, adding distilled water to dissolve the lithium acetate and the reductant, and stirring for 1-10 hr at 20-90 until evaporation to dryness to give lithium iron phosphate precursor; (2) treating the precursor at 300-800 for 0.5-5 hr in protection atmosphere to give lithium iron phosphate; and (3) weighing the lithium iron phosphate and carbon source, adding distilled water to dissolve the carbon source, heating while stirring until evaporation to dryness, treating at 500-800 for 0.5-5 hr in protection atmosphere to give carbon-coated lithium iron phosphate. As disclosed in that public literature, the battery prepared by using the obtained carbon-coated lithium iron phosphate can give initial discharge capacity up to 167 mAh/g, but the battery has poor large-current discharge performance and cycle performance.

### SUMMARY OF THE INVENTION

The object of the present invention is to overcome the disadvantages of the lithium iron phosphate prepared by conventional methods, such as large particle size and nonuniform particle size distribution of the lithium iron phosphate grains, and low initial discharge specific capacity, poor large-current discharge performance and poor cycle performance of the battery prepared from the lithium iron phosphate; and to provide a method for preparing lithium iron phosphate with small particle size and uniform particle size distribution, wherein the battery prepared from the lithium iron phosphate obtained by the present method has high initial discharge specific capacity, and good large-current discharge property and cycle performance.

The inventor found that the reason for the large particle size and nonuniform particle size distribution of the lithium iron phosphate prepared by conventional methods is that: (1) it is very difficult for each component to separate out during drying after lithium source, iron source, phosphorus source and carbon source are mixed in water, which leads to nonuniform distribution of each element in obtained precursor; (2) moreover, individual crystallization of each component during drying is prone to caking, which makes precursor particle size difficult to control, thus lithium iron phosphate prepared by the aforementioned method has large particle size, and nonuniform particle size distribution. Therefore, when the aforementioned lithium iron phosphate is used as positive electrode active material, the obtained battery has low initial discharge specific capacity, and poor large-current discharge performance and cycle performance.

The present invention provides a method for preparing LiFePO₄ as a positive electrode active material for a lithium ion secondary battery, comprising drying and sintering a mixture containing a lithium source, ferric source, phosphorus source, a carbon source, and a solvent, wherein the solvent is water and/or water soluble organic solvent, the ferric source is ferric oxide (Fe₂O₃), and the phosphorus source is phosphoric acid (H₃PO₄).

Compared with prior art, the method according to the present invention can obtain a precursor with small particle size and uniform particle size distribution by using ferric oxide as the iron source and phosphoric acid as the phosphorus source. The possible explanation for the result is assumed to be that (1) a complex is formed under the action of phosphoric acid when lithium source, ferric oxide, phosphoric acid, and carbon source are mixed in water and/or water soluble organic solvent, and in the solution, the complex can form a relatively stable sol-like material with elements uniformly distributed therein; (2) during drying, the components in sol-like matter adopt ferric oxide fine particle as core, and attach on the surface of the ferric oxide particle to regularly separate out, which thus avoids caking occurred in individual crystallization of each component of precursor, so as to obtain precursor with small particle size and uniform particle size distribution. The obtained lithium iron phosphate after sintering of the precursor has small particle size and uniform particle size distribution, and the battery prepared from the lithium iron phosphate has high initial discharge specific capacity, and significantly improved large-current discharge performance and cycle performance.

### BRIEF DESCRIPTION OF THE DRAWINGS

FIG. 1 is the XRD diffraction pattern of the lithium iron phosphate prepared by the method according to the present invention in example 1;

FIG. 2 is the SEM image of the lithium iron phosphate prepared by the method according to the present invention in example 1; and

FIG. 3 is the SEM image of the lithium iron phosphate prepared by the conventional method in comparison example 1.

### DETAILED DESCRIPTION OF THE EMBODIMENTS

The method provided in the present invention comprises drying and sintering a mixture containing a lithium source, ferric source, phosphorus source, a carbon source, and a solvent, wherein the solvent is water and/or water soluble organic solvent, the ferric source is ferric oxide (Fe₂O₃), and the phosphorus source is phosphoric acid (H₃PO₄).

The Molar Ratio of the Lithium Source, Ferric Oxide, and Phosphoric Acid is Li:Fe:P=0.95-1.1:1:0.95-1.1; based on 100 weight parts of ferric oxide, the amount of the carbon source is 30-110 weight parts, and preferably 45-70 weight parts, and the amount of the solvent is 125-500 weight parts, and preferably 150-350 weight parts. The mixture containing a lithium source, ferric oxide, phosphoric acid, a carbon source, and a solvent may be prepared by mixing the lithium source, ferric oxide, phosphoric acid, and carbon source in the solvent, and the mixing condition is not specifically limited as long as it is able to ensure that all raw materials can fully contact and react, and each element in the precursor can be uniformly mixed. For example, the mixing time can be 0.5-6 hr, and the mixing temperature can be 5-60° C. There is no special restriction on mixing sequence of each raw material, for example, one or more of lithium source, ferric oxide, phosphoric acid, and carbon source can be added into the solvent, and then the rest materials are added; or lithium source, ferric oxide, phosphoric acid, and carbon source can be simultaneously added into the solvent. In the mixing process, stirring can be carried out, and the stirring speed can be 100-3,000 rpm.

The lithium source can be any lithium-containing compound capable of providing lithium element for the reaction while not bringing impurities into the product, which can be one or more selected from lithium hydroxide, lithium hydroxide monohydrate, lithium carbonate, lithium phosphate, lithium phosphate dodecahydrate, lithium oxalate, and lithium acetate, and preferably lithium hydroxide monohydrate.

Ferric oxide is insoluble in the solvent (water and/or water soluble solvent) and unreactive with phosphoric acid, therefore it acts as core to be attached by other components separated out during the precursor formation process. The smaller and more uniform the ferric oxide particle size is, the smaller and more uniform the formed precursor is, which is more beneficial for preparing lithium iron phosphate with small particle size and uniform particle size distribution. Therefore, ferric oxide preferably has median particle size D₅₀ no more than 0.7 micron and D95 no more than 5.0 micron, and more preferably D₅₀ within 0.2-0.6 micron, and D95 within 1.5-4.5 micron, wherein D₅₀ represents sample average particle size, i.e. the tested sample has 50% of particles with particle size smaller than that value, and 50% of particles with particle size larger than that value; D95 means that the tested sample has 95% of particles with particle size smaller than that value, and 5% of particles with particle size larger than that value.

Ferric oxide and phosphoric acid both are regular chemical materials, with mature production process and low cost.

The carbon source can be various conventional carbon sources used in lithium iron phosphate preparation process, such as one or more selected from terpolymer of benzene, naphthalene, and phenanthrene, binary copolymer of benzene and phenanthrene, binary copolymer of benzene and anthracene, soluble starch, polyvinyl alcohol, sucrose, glucose, fructose, lactose, maltose, phenolic resin, furfural resin, artificial graphite, natural graphite, acetylene black, carbon black, and mesocarbon microbeads, and among them, one or more selected from sucrose, glucose, fructose, lactose, and maltose is preferred. The carbon source has two functions: (1) a part of the carbon source reduces ferric ions into ferrous ions during sintering process; and (2) the other part of the carbon source dopes carbon element into the lithium iron phosphate.

The solvent can be water and/or water soluble organic solvent, and preferably water. The water soluble organic solvent can be water soluble organic solvent with boiling point less than 200° C., preferably one or more of methanol, ethanol and propanol. Preferably, the mixture may further contain nitrate of metal M selected from the group consisting of Mn, Co, Ni, Ca, Mg, Zn, Ti, Nb, Y, Mo, Cu, Au, Ga, Zr, V and Al. The M is called dopant element, which can increase ion conductivity of lithium iron phosphate so as to improve large-current charge-discharge performance of the battery using lithium iron phosphate as positive electrode active material. The molar ratio of M to Fe is 0.005-0.25:1, and preferably 0.01-0.1:1.

The mixture may preferably further contain a halogen compound selected from the group consisting of lithium fluoride, lithium chloride, lithium bromide, and lithium iodide, with which the battery has higher capacity and improved large-current discharge performance. Preferably, the halogen compound has D95 no more than 3 micron, and more preferably 0.3-3 micron. According to this preferred embodiment, the prepared positive electrode active material has smaller particle size and more uniform particle size distribution, and the battery prepared by the positive electrode active material has higher mass specific capacity and improved large-current discharge performance. The molar ratio of halogen in the halogen compound to iron may be 0.005-0.25:1, and preferably 0.01-0.1:1.

The drying can be carried out by various drying methods used in the technical field, preferably baking. The baking temperature can be 80-160° C., and preferably 100-120° C., and the baking time is 5-40 hr, and preferably 8-24 hr.

The sintering can be one-stage sintering or two-stage sintering under protection of inert gas atmosphere. The one-stage sintering preferably comprises heating to 600-800° C. at a rate of 1-10° C./min, and keeping the temperature for 6-20 hr. The two-stage sintering preferably comprises heating to 300-500° C. at a rate of 1-10° C. /min and keeping the temperature for 5-8 hr at the first stage; and heating to 600-800° C. at a rate of 1-10° C./min and keeping the temperature for 8-20 hr at the second stage.

The inert atmosphere refers to any one or more gases unreactive with the reactant and the product, such as one or more of nitrogen gas and Group 0 gases in the element period table.

The present invention will be described in further details by way of examples as below.

### Example 1

This example describes the method provided in the present invention for preparing lithium iron phosphate positive electrode active material.

43.3 g of LiOH.H₂O (Shanghai China-Lithium Industrial Co., Ltd., battery grade, containing 97.01 wt % of LiOH.H₂O), 80.4 g of Fe₂O₃ with median particle size D₅₀ of 0.37 micron and D₉₅ of 2.50 micron (ELEMENTIS, containing 99.3% of Fe₂O₃), 115.0 g of H₃PO₄ (Guangzhou Guanghua Chemical Reagent Co. Ltd., analytical grade, containing 85.2% of H₃PO₄), 38.2 g of sucrose (Guangzhou Guanghua Chemical reagent Co. Ltd., analytical grade), and 200 ml of dionizied water were introduced into a reactor, stirred at 200 rpm for 1.5 hr, and dried at 120° C. for 8 hr to obtain a precursor. The precursor was heated to 690° C. at a rate of 5° C./min, sintered at 690° C. in nitrogen atmosphere for 8 hr, and then naturally cooled to room temperature to obtain the inventive lithium iron phosphate positive electrode active material.

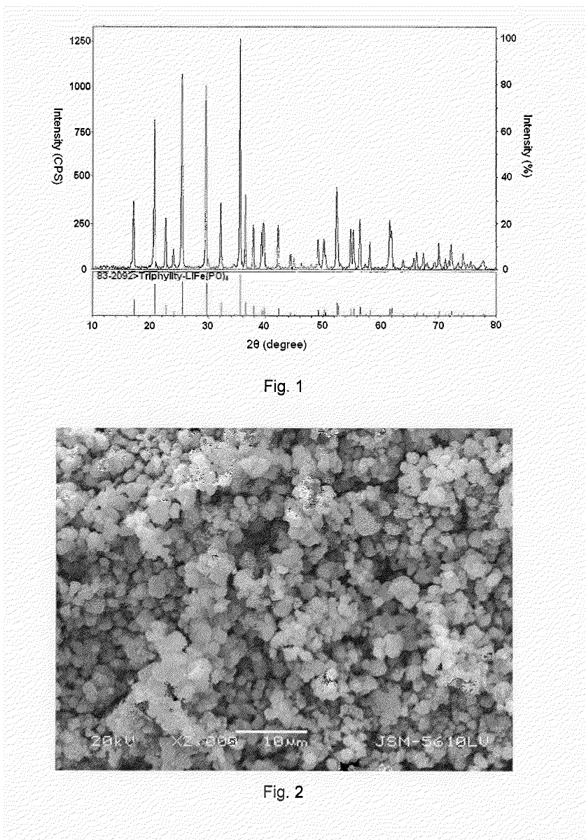

X-ray powder diffractometer (Rigaku Corporation, D/MAX2200PC) was adopted to analyze LiFePO₄/C positive electrode material to give XRD pattern as shown in FIG. 1. Scanning electronic microscope (JOEL, JSM-5610LV) was adopted to analyze the sample to give SEM image as shown in FIG. 2. It can be observed from the XRD pattern that the lithium iron phosphate exhibits good crystallization without any impurity peak. It can be observed from the SEM image that the particle size distribution is uniform.

### Examples 2-6

Lithium iron phosphate positive electrode active material was prepared according to the method in the example 1, in which kind and amount of lithium source, amount and particle size of ferric oxide, amount of phosphoric acid, kind and amount of carbon source, kind and amount of solvent, drying temperature and time, and sintering temperature and time were shown in Table 1.

TABLE 1

| | Example 2 | Example 3 | Example 4 | Example 5 | Example 6 |
|---|---|---|---|---|---|
| Lithium source | LiOH•H₂O | LiOH•H₂O | Li₂CO₃ | Li₂CO₃ | Li₂CO₃ |
| Amount of lithium | 42 | 45 | 39 | 39 | 38 |
| source (g) | | | | | |
| Amount of ferric oxide | 80 | 85 | 80 | 80 | 80 |
| (g) | | | | | |
| Ferric oxide particle size | 0.42 | 0.66 | 0.31 | 0.37 | 0.50 |
| D₅₀ (micron) | | | | | |
| Ferric oxide particle size | 2.53 | 4.89 | 1.97 | 2.50 | 3.64 |
| D₉₅ (micron) | | | | | |
| Amount of phosphoric | 115 | 118 | 115 | 114 | 115 |
| acid (g) | | | | | |
| Carbon source | Sucrose | sucrose | glucose | fructose | fructose |
| Amount of carbon source | 47 | 56 | 40 | 50 | 60 |
| (g) | | | | | |
| Solvent | 230 ml | Mixed solvent | 190 ml | 200 ml | 210 ml |
| | water | of 120 ml | ethanol | water | ethanol |
| | | water and | | | |
| | | 120 ml ethanol | | | |
| Drying temperature (° C.) | 80 | 100 | 120 | 140 | 160 |
| Drying time (hr) | 40 | 30 | 20 | 12 | 5 |
| Sintering | 600 | 630 | 700 | 750 | 800 |
| temperature (° C.) | | | | | |
| Sintering time (hr) | 5 | 10 | 12 | 18 | 15 |

### Example 7

43.3 g of LiOH.H₂O (Shanghai China-Lithium Industrial Co., Ltd., battery grade, containing 97.01 wt % of LiOH.H₂O), 80.4 g of Fe2O3 with median particle size D₅₀ of 0.37 micron and D₉₅ of 2.5 micron (ELEMENTIS, containing 99.3% of Fe₂O₃), 115.0 g of H₃PO₄ (Guangzhou Guanghua Chemical reagent Co. Ltd., analytical grade, containing 85.2% of H₃PO₄), 38.2 g of sucrose (Guangzhou Guanghua Chemical reagent Co. Ltd., analytical grade), 2.45 g (0.01 mol) of Ni(NO₃)₃, 1.89 g (0.01 mol) of Zn(NO₃)₂, and 200 ml of dionizied water were introduced into a reactor, stirred at 200 rpm for 1.5 hr, and dried at 120° C. for 8 hr to obtain a precursor. In nitrogen atmosphere, the precursor was heated to 500° C. at 2° C./min, and sintered at 500° C. for 4 hr, and then heated to 700° C. at 2° C./min, and sintered at 700° C. for 10 hr. The sintering product was naturally cooled to room temperature to obtain the lithium iron phosphate positive electrode active material provided in the present invention.

### Example 8

Lithium iron phosphate positive electrode active material was prepared according to the method in the example 7, except that 2.45 g (0.01 mol) of Ni(NO₃)₃ and 1.89 g (0.01 mol) of Zn(NO₃)₂ were replaced by 17.76 g (0.06 mol) Ti(NO₃)₄.

### Example 9

Lithium iron phosphate positive electrode active material was prepared according to the method in the example 7, except that 2.45 g (0.01 mol) of Ni(NO₃)₃ and 1.89 g (0.01 mol) of Zn(NO₃)₂ were replaced by 5.92 g (0.04 mol) of Mg(NO₃)₂, and LiCl was further added at the amount of 0.85 g (0.02 mol).

### Example 10

Lithium iron phosphate positive electrode active material was prepared according to the method in the example 1, except that 1.56 g (0.06 mol) of LiF was further added during mixing the raw materials.

### Comparison Example 1

The comparison example describes the conventional method for preparing lithium iron phosphate positive electrode active material disclosed in the example 1 of CN 1442917A.

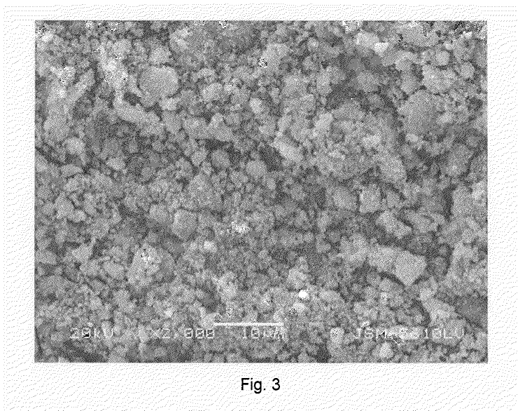

2 ml of glycerol was dropwise added into 10 ml of deionized water, and stirred well. 3.45 g of LiNO₃, 9 g of FeC₂O₄.9H₂O and 5.8 g of NH₄H₂PO₄ were added thereto while high speed stirring, stirred for 1 hr, dried at 120° C. in N₂ atmosphere. After elevating the temperature to 600° C. in N₂ atmosphere, the dried product was baked for 24 hr, and then naturally cooled. Scanning electronic microscope (JOEL, JSM-5610LV) was adopted to analyze the sample to give SEM image as shown in FIG. 3. By comparing FIG. 2 and FIG. 3, lithium iron phosphate prepared in the comparison example 1 has less uniform particle size distribution than that in the example 1.

### Comparison Example 2

The comparison example explains the conventional method for preparing lithium iron phosphate positive electrode active material disclosed in the example 3 of CN 1821062A, comprising steps as below:
(1) Weighing ferric phosphate, lithium acetate, and urea at ferric phosphate/lithium acetate molar ratio of 1:1 and ferric phosphate/urea molar ratio of 1:3, adding distilled water to dissolve lithium acetate and urea, stirring at 80° C. for 6 hr, and evaporating to dryness to give lithium iron phosphate precursor;
(2) Treating the precursor at 700° C. for 3 hr under protection of gas mixture containing argon gas and 5 vol % of hydrogen gas to give lithium iron phosphate; and
(3) Weighing lithium iron phosphate and sucrose at weight ratio of 92:8, dissolving sucrose in distilled water, heating while stirring, evaporating to dryness, treating at 650° C. for 2 hr to give carbon-coated lithium iron phosphate.

### Performance Test

### (1) Particle Size Distribution Test

MASTERSIZER X100 laser particle size analyzer (HONEYWELL, US) was adopted to respectively measure particle sizes of lithium iron phosphate grains prepared in the examples 1-10 and the comparison example 1, and the measurement result was shown in Table 2.

TABLE 2

| | D₁₀ (micron) | D₅₀ (micron) | D₉₀ (micron) |
|---|---|---|---|
| Example 1 | 0.91 | 3.84 | 7.10 |
| Example 2 | 0.79 | 3.01 | 6.49 |
| Example 3 | 0.97 | 4.27 | 7.92 |
| Example 4 | 0.75 | 2.34 | 6.01 |
| Example 5 | 0.88 | 3.53 | 7.53 |
| Example 6 | 0.94 | 3.74 | 7.71 |
| Example 7 | 0.90 | 3.82 | 7.09 |
| Example 8 | 0.91 | 3.85 | 7.12 |
| Example 9 | 0.84 | 3.62 | 6.70 |
| Example 10 | 0.82 | 3.58 | 6.65 |
| Comparison | 2.55 | 8.55 | 19.35 |
| Example 1 | | | |

In the above table, D₅₀ represents sample average particle size, i.e., the tested sample has 50% particles with particle size smaller than that value, and 50% particles with particle size larger than that value; D₁₀ means that the tested sample has 10% particles with particle size smaller than that value, and 90% particles with particle size larger than that value; D₉₀ means that the tested sample has 90% particles with particle size smaller than that value, and 10% particles with particle size larger than that value. Therefore, the bigger the difference between D₅₀ and D₁₀ and the difference between D₅₀ and D₉₀ are, the less uniform the particle size distribution is. It could be seen from the Table 2 that, the difference between D₅₀ and D₁₀ and the difference between D₅₀ and D₉₀ of grains prepared in the examples 1-10 are not more than 4.0 micron, while the difference between D₅₀ and D₁₀ and the difference between D₅₀ and D₉₀ of the grains prepared in the comparison example 1 are respectively 6.0 micron and 10.8 micron, indicating that lithium iron phosphate prepared by the inventive method has uniform particle size distribution and uniform particle size.

Moreover, from data in Table 2, compared with the lithium iron phosphate prepared by the comparison example method, the lithium iron phosphate grains prepared by the present invention have smaller particle size.

### (2) Battery Preparation

### Positive Electrode Preparation

90 g of LiFePO₄ positive electrode active material prepared by the examples 1-10 and the comparison examples 1 and 2 respectively, 5 g of poly(vinylidene difluoride) (PVDF) binder, and 5 g of acetylene black conductive agent were added into 50 g of N-methylpyrrolidone, and stirred in a vacuum mixer to form uniform positive electrode slurry. The slurry was uniformly coated on both sides of 20 micron-thick aluminum foil, dried at 150° C., rolled, and cut into 540 mm×43.5 mm positive electrode containing 5.3 g LiFePO4 as active component.

### Cathode Preparation

90 g of natural graphite as cathode active component, 5 g of PVDF binder, and 5 g of carbon black conductive agent were added into 100 g of N-methylpyrrolidone, and stirred in a vacuum mixer to form uniform negative electrode slurry. The slurry was uniformly coated on both sides of 12 micron-thick copper foil, dried at 90° C., rolled, and cut into 500 mm×44 mm negative electrode containing 3.8 g of natural graphite as active component.

### Battery Assembly

The above-mentioned positive electrode, cathode, and polypropylene membrane were respectively into a square lithium ion battery core. 1M LiPF₆ was dissolved in a mixed solvent of EC/EMC/DEC (1:1:1) to form a non aqueous electrolyte. The electrolyte was injected into a battery aluminum casing at 3.8 g/Ah, and the casing was sealed to prepare lithium ion secondary batteries A1-A10 in the present invention, and lithium ion secondary batteries AC1 and AC2 in the comparison examples, respectively.

### (3) Battery Initial Discharge Specific Capacity Test

The test comprises respectively charging the batteries A1-A10, AC1 and AC2 at constant current of 0.2 C with charging upper limitation set at 4.2V, setting aside for 20 min, discharging from 4.2V to 2.5V at constant current of 0.2 C, recording the initial discharging capacity, and calculating the battery mass specific capacity according to equation as below:

Mass specific capacity=battery initial discharge capacity (mAh)/positive electrode material weight (g)

The result is shown in Table 3.

TABLE 3

| | | Battery initial discharge | Mass specific |
|---|---|---|---|
| Example No. | Battery No. | capacity (mAh) | capacity (mAh/g) |
| Example 1 | A1 | 792.7 | 149.6 |
| Example 2 | A2 | 757.2 | 142.9 |
| Example 3 | A3 | 749.1 | 141.3 |
| Example 4 | A4 | 801.4 | 151.2 |
| Example 5 | A5 | 780.4 | 147.2 |
| Example 6 | A6 | 764.0 | 144.2 |
| Example 7 | A7 | 810.2 | 152.9 |
| Example 8 | A8 | 812.4 | 153.3 |
| Example 9 | A9 | 816.9 | 154.1 |
| Example 10 | A10 | 812.7 | 153.3 |
| Comparison | AC1 | 650.4 | 122.7 |
| example 1 | | | |

From the data in Table 3, it can be observed the battery AC1 prepared from the lithium iron phosphate by the method in the comparison example 1 has undesirable initial discharge capacity and mass specific capacity, while the battery A1-A10 prepared from the lithium iron phosphate by the present invention has significantly improved initial discharge capacity and mass specific capacity.

### (4) Large-Current Discharge Performance Test

The batteries A1-A10, AC1, and AC2 are respectively subjected to large-current discharge test at normal temperature and relative humidity of 25-85%. The test method comprises: adopting BS-9300(R) secondary battery performance test device to charge the battery to be tested to 3.8V at current of 0.2 C, setting aside for 5 min, discharging to 2.0V at current of 1 C, setting aside for 5 min, charging to 3.8V at constant current of 0.2 C, and charging at constant voltage of 3.8V with cutoff current of 0.02 C; respectively discharging the charged battery at 0.2 C, 1 C, and 3 C to battery voltage of 2.0V, and recording the discharge capacity.

Discharge capacity (mAh)=discharge current (mA)×discharge time (hr)

Discharge rate=1 C or 3 C discharge capacity/0.2 C discharge capacity×100%

The result is shown in Table 4

TABLE 4

| | | 1 C/0.2 C | 3 C/0.2 C |
|---|---|---|---|
| | | Discharge ratio | Discharge ratio |
| Example No. | Battery No. | (%) | (%) |
| Example 1 | A1 | 95.3 | 92.4 |
| Example 2 | A2 | 94.8 | 91.7 |
| Example 3 | A3 | 94.3 | 91.4 |
| Example 4 | A4 | 96.4 | 92.6 |
| Example 5 | A5 | 94.9 | 92.2 |
| Example 6 | A6 | 95.0 | 92.1 |
| Example 7 | A7 | 95.9 | 92.6 |
| Example 8 | A8 | 96.1 | 92.9 |
| Example 9 | A9 | 96.5 | 93.1 |
| Example 10 | A10 | 96.2 | 93.0 |
| Comparison example 1 | AC1 | 74.0 | 50.3 |
| Comparison example 2 | AC2 | 79.1 | 68.6 |

According to the data in Table 4, the batteries AC1 and AC2 show undesirable large-current discharge performance, while the batteries A1-A10 have significantly improved large-current discharge performance.

### (5) Cycle Performance Test

The batteries A1-A10, AC1, and AC2 are respectively subjected to cycle performance test at normal temperature and relative humidity of 25-85%. The test method comprises steps as below:

Firstly, adopting BS-9300(R) secondary battery performance test device to charge the battery to be tested to 3.8V at current of 0.2 C, setting aside for 5 min, discharging to 2.5V at current of 1 C, setting aside for 5 min, and charging to 4.2V at constant current of 0.2 C with charge cutoff current at 20 mA; discharging at 200 mA to 2.5V, and measuring the discharge initial capacity of the battery; repeating charge-discharge cycle of charging to 4.2V at constant current of 0.2 C and discharging to 2.5V at 0.2 C, recording the thirtieth cycle end capacity, and calculating the battery capacity residual rate according to equation as below:

Capacity residual rate=the thirtieth cycle end capacity/initial capacity×100%

The test result is shown in Table 5.

TABLE 5

| | Battery | Capacity residual |
|---|---|---|
| Example No. | No. | ratio after 30 cycles |
| Example 1 | A1 | 98.62 |
| Example 2 | A2 | 98.15 |
| Example 3 | A3 | 97.96 |
| Example 4 | A4 | 98.91 |
| Example 5 | A5 | 98.44 |
| Example 6 | A6 | 97.87 |
| Example 7 | A7 | 98.97 |
| Example 8 | A8 | 99.01 |
| Example 9 | A9 | 99.13 |
| Example 10 | A10 | 99.04 |
| Comparison example 1 | AC1 | 91.53 |
| Comparison example 2 | AC2 | 92.15 |

According to the data in Table 5, compared with the batteries prepared from lithium iron phosphate obtained by the method in prior arts, the batteries prepared by the present invention have significantly improved cycle performance.

1-10. (canceled)

11. A method for preparing a composite comprising:
mixing a lithium-containing compound, ferric oxide, phosphoric acid, a precursor for carbon, and water to provide a mixture; and
sintering the mixture to provide a composite.

12. The method of claim 11, wherein the mixture further comprises a water-miscible solvent.

13. The method of claim 12, wherein the water-miscible solvent is selected from the group consisting of methanol, ethanol, propanol, and combinations thereof.

14. The method of claim 11, wherein the sintering is carried out in an inert atmosphere at a temperature in a range of between about 600 and about 800° C. for about 6 to about 20 hours; and wherein the temperature increases at a rate in a range of between about 1 and about 10° C./min.

15. The method of claim 11, wherein the sintering comprises steps of:
heating the mixture at a temperature in a range of between about 300 and about 500° C. for about 5 to about 8 hours; and
heating the mixture at a temperature in a range of between about 600 and about 800° C. for about 8 to about 20 hours.

16. The method of claim 11, further comprising a step of: drying the mixture;
wherein the drying is carried out at a temperature of between about 80 and about 160° C. for about 5 to about 40 hours.

17. The method of claim 11, wherein the molar ratio of the lithium, iron, and phosphorus is about (0.95-1.1):1:(0.95-1.1).

18. The method of claim 11, wherein the weight ratio of the ferric oxide, the precursor of carbon, and water is about 100:(30-110):(125-500).

19. The method of claim 11, wherein the ferric oxide is in the form of particles,
wherein about 50% of the ferric oxide particles have a diameter smaller than about 0.7 μm, and about 95% of the particles have a diameter smaller than about 5.0 μm.

20. The method of claim 19, wherein about 50% of the ferric oxide particles have a diameter smaller than about 0.6 μm, and about 95% of the particles have a diameter smaller than about 4.5 μm.

21. The method of claim 11, wherein the lithium-containing compound is selected from the group consisting of lithium hydroxide, lithium hydroxide monohydrate, lithium carbonate, lithium phosphate, lithium phosphate dodecahydrate, lithium oxalate, lithium acetate, and combinations thereof.

22. The method of claim 11, wherein the precursor of carbon is selected from the group consisting of sucrose, glucose, fructose, lactose, maltose, and combinations thereof.

23. The method of claim 11, wherein the mixture further comprises a metal nitrate.

24. The method of claim 23, wherein the metal nitrate comprises an element selected from the group consisting of Mn, Co, Ni, Ca, Mg, Zn, Ti, Nb, Y, Mo, Cu, Au, Ga, Zr, V, Al, and combinations thereof.

25. The method of claim 23, wherein the molar ratio of the metal in the metal nitrate to iron is about (0.005-0.25):1.

26. A method for preparing a composite comprising:
mixing a lithium-containing compound, ferric oxide, phosphoric acid, a precursor of carbon, and a solvent to provide a gel-like mixture; and
sintering the mixture to provide a composite.

27. The method of claim 26, wherein the solvent is selected from the group consisting of water, a water-miscible solvent, and combinations thereof.

28. A method for preparing a composite comprising:
mixing a lithium-containing compound, ferric oxide, phosphoric acid, a precursor for carbon, a halogen compound, and a solvent to provide a mixture; wherein the solvent is selected from the group consisting of water, a water-miscible solvent, and combinations thereof; and
sintering the mixture to provide a composite.

29. The method of claim 28, wherein the halogen compound is selected from the group consisting of lithium fluoride, lithium chloride, lithium bromide, lithium iodide, and combinations thereof.

30. The method of claim 28, wherein the molar ratio of halogen in the halogen compound to iron is about (0.005-0.25):1.
